(19) United States
(12) Patent Application Publication
(10) Pub. No.: US 2017/0206403 A1
(43) Pub. Date: Jul. 20, 2017

(54) METHOD OF DISTRIBUTED FACE RECOGNITION AND SYSTEM THEREOF

(71) Applicants: Jason RAMBACH, Darmstadt (DE); Marco HUBER, Weinheim (DE); Mark Ryan BALTHASAR, Wiesbaden (DE)

(72) Inventors: Jason RAMBACH, Darmstadt (DE); Marco HUBER, Weinheim (DE); Mark Ryan BALTHASAR, Wiesbaden (DE)

(21) Appl. No.: 15/000,413

(22) Filed: Jan. 19, 2016

(51) Int. Cl. G06K 9/00; G06K 9/52; G06K 9/62

(52) U.S. Cl. CPC G06K 9/00288; G06K 9/00268; G06K 9/6215; G06K 9/52

(57) ABSTRACT

A method and system of recognizing a face image comprising a plurality of processing nodes. Nodes obtain parts of the face image and extract features of the obtained part thereby generating a feature template. Nodes compare the feature template with stored subject templates and calculate an initial similarity score in respect of each comparison, thereby generating an initial score vector associated with a plurality of subjects. Nodes average the initial similarity score vectors generated by it and by at least two predefined nodes, giving rise to an intermediate score vector. The intermediate score vector is repeatedly averaged until a convergence condition is met, thereby generating a final score vector. A node associates the face image to the subject corresponding to the highest score in the final score vector thereby recognizing the face image.

### TECHNICAL FIELD

The presently disclosed subject matter relates to face recognition and, more particularly, to distributed face recognition of a face image.

### BACKGROUND

Biometric recognition refers to matching a person to a previously known identity based on observed characteristics. It can be applied to user authentication systems, for example, to grant physical access to an area, or to provide access to data on a device. It is also of importance to surveillance applications, for instance, to detect subjects that belong to a list of unwanted people, etc.

Face recognition is one of the most widely used biometric recognition techniques because of several advantages compared to other biometrics. For example, there is a lot of variation between peoples' faces, which provides highly distinguishing information for recognition. Furthermore, face recognition is considered less intrusive than other biometrics. A face image can be acquired by a camera from a distance, without the cooperation of the subject, as opposed to fingerprints or an iris image.

Given a face image to recognize, the recognition process can be divided into three main tasks: face detection, feature extraction, and face matching, respectively. Face detection is the task of segmenting the face areas from the background of a given image, and usually performing some post-processing on the acquired face image such as histogram equalization, normalization and/or geometric alignment. Feature extraction is then performed on the segmented face areas. In the feature extraction stage, the dimensionality of the face data is reduced by extracting meaningful information from it, and using the extracted information to create a face template for making face comparisons more efficient. Finally, in the face matching stage, the face template of the query face is compared to a database of face templates of known subjects (also called “enrolled subjects”) that were previous collected and stored, for example during a training or enrolment phase. The system finds the closest matching template, thereby determining the subject of the face image.

Although face recognition is a trivial task for humans, automated face recognition still has challenges. For example, illumination variations between images, as well as different poses and facial expressions, make it a challenging task. Apart from that, people change their appearance regularly, for instance, by wearing glasses or hats, or growing beards. A person's face also changes with the person's age. Some of these challenges can be alleviated using modular face recognition. Modular face recognition refers to separately comparing individual face modules (e.g. mouth nose, eyes, etc.), or combinations of face modules, rather than (or in addition to) recognizing the whole face. In modular recognition, the features of each face module are extracted separately. The extracted features of each module can then be combined to create a single face template, or separate templates can be created for each module.

In distributed face recognition systems, at least some of the processing described above is distributed amongst different processing entities, or nodes, in a network. Problems of distributed face recognition have been recognized in the conventional art and various techniques have been developed to provide solutions, for example:

Yan, Yanjun and Osadciw, Lisa Aim, “Fusion for Component based Face Recognition” (2007), Electrical Engineering and Computer Science, Paper 68; This paper discloses a face recognition system fusing the classification results from the components (characteristic regions such as eyes, nose and mouth) and from the whole face image, instead of concatenating the face feature and the modular features for a single classifier.

Y. Yan and L. A. Osadciw, “Distributed wireless face recognition system”, Proc. of IS&T and SPIE Electronic Imaging, San Jose, Calif., USA, 2008 (“Yan and Osadciw”); This paper discloses a distributed wireless network prototype, consisting of feature net and database net using subspace-based modular processing with score and decision level fusion.

M. I. Razzak, B. A. Elmogy, M. K. Khan, and K. Alghathbar. “Efficient distributed face recognition in wireless sensor network”, International Journal of Innovative Computing, Information and Control, vol. 8 no. 4, pp. 2811-2822 (2012); This paper presents a collaborative face recognition system in a wireless sensor network. The layered linear discriminant analysis is re-engineered to implement on a wireless sensor network by efficiently allocating the network resources.

Q. Lin, J. Yang, B. Zhang, R. Wang, N. Ye, and M. Yan. “Distributed face recognition in wireless sensor networks”, International Journal of Distributed Sensor Networks (2014); This paper discloses the application of the face recognition technique in wireless sensor networks. A facial component-based recognition mechanism is firstly applied to ensure the recognition accuracy. Secondly, in order to address the problem of resource constraints, a distributed scheme based on K-d trees is deployed for both the face image transmission and retrieval. According to the simulation results, the proposed method is capable of achieving considerable energy efficiency, while assuring the recognition accuracy.

International Patent Application No. WO 2013081517 “Method for performing face recognition in a radio access network” discloses a method for performing face recognition in a telecommunication system comprising a central repository in which face recognition profiles attached to subscribers signed up for face recognition have been stored. The method comprises steps like: detecting proximity between a subscriber of the subscribers signed up for face recognition and an entity involved with face recognition, said subscriber being located within a cell coverage area; migrating a face recognition profile attached to said subscriber, from the central repository to a network node controlling the cell coverage area; generating in the network node, an extended synthetic gallery for the migrated Face Recognition profile.

Chinese Patent Application No. CN 102184391, “Distributed type face recognition method and system as well as face recognition terminal” discloses a distributed type face recognition method and system as well as a face recognition terminal, belonging to the technical fields of biometrics recognition and network data transmission. The method comprises the following steps: arranging a first face recognition terminal and at least one second face recognition terminal connected with the first face recognition terminal by virtue of a network; using the first face recognition terminal to acquire a face image of a user to be recognized, and extract the features of the face to be recognized; using the first face recognition terminal to recognize the features of the face to be recognized, if the recognition is unsuccessful, sending a recognition request carrying the features of the face to be recognized to the second face recognition terminal for recognition, and returning the recognition result; and according to the received recognition result returned by the second face recognition terminal, prompting that the recognition is successful or failed by the first face recognition terminal. According to the invention, the user can carry out face recognition on any one networked face recognition terminal, thus providing great convenience for the user.

The references cited above teach background information that may be applicable to the presently disclosed subject matter. Therefore the full contents of these publications are incorporated by reference herein where appropriate for appropriate teachings of additional or alternative details, features and/or technical background.

### General Description

The distributed face recognition systems of the prior art typically execute in a centralized fashion, meaning the data processed at different nodes are collected and aggregated at a central processing node (called a sink node in the following), for further processing or taking a recognition decision.

In many cases of distributed processing, aggregation by a sink node introduces a single point of failure, that being the sink node.

In accordance with certain aspects of the presently disclosed subject matter, there is provided a method of operating a plurality of operatively interconnected processing nodes to associate a face image with a subject out of a plurality of subjects. The method comprises, by each node out of the plurality of processing nodes: obtaining, at least part of the face image and extracting features of the obtained at least part of the face image thereby generating a feature template comprising the extracted features, the features extracted by any given node being different than the features extracted by at least one other node. The method further comprises, by each node out of the plurality of processing nodes, comparing the feature template generated by the node with each subject template out of a plurality of subject templates stored in the node, each stored subject template comprising features of a corresponding at least part of a face image of a different subject out of the plurality of subjects, and calculating an initial similarity score in respect of each comparison, thereby generating an initial score vector informative of a plurality of initial similarity scores associated with a respective plurality of subjects. The method further comprises, by each node out of the plurality of processing nodes, averaging the initial similarity score vectors generated by the node and by at least two predefined nodes out of the plurality of processing nodes, thereby giving rise to an intermediate similarity score vector. The method further comprises, by each node out of the plurality of processing nodes, repeatedly averaging the intermediate similarity score vectors generated by the node and by the at least two predefined nodes until a convergence condition is met, thereby generating a final score vector compatible for all nodes out of the plurality of processing nodes and informative of one or more average similarity scores, each associated with a respective subject out of the plurality of subjects. The method further comprises, by at least one node out of the plurality of processing nodes, associating the face image with the subject that corresponds to the highest score in the node's final score vector.

In accordance with certain other aspects of the presently disclosed subject matter, there is provided a face recognition system for associating a face image with a subject out of a plurality of subjects. The system comprises a plurality of operatively interconnected processing nodes, each node comprising a processor operatively coupled to a memory. The processor is configured to obtain, from the memory, at least part of the face image, and extract features of the obtained at least part of the face image thereby generating a feature template comprising the extracted features, the features extracted by any given node being different than the features extracted by at least one other node. The processor is further configured to compare the feature template generated by the node with each subject template out of a plurality of subject templates stored in the node, each stored subject template comprising features of a corresponding at least part of a face image of a different subject out of the plurality of subjects, and calculate an initial similarity score in respect of each comparison, thereby generating an initial score vector informative of a plurality of initial similarity scores associated with a respective plurality of subjects. The processor is further configured to average the initial similarity score vectors generated by the node and by at least two predefined nodes out of the plurality of processing nodes, thereby giving rise to an intermediate similarity score vector. The processor is further configured to repeatedly average the intermediate similarity score vectors generated by the node and by the at least two predefined nodes until a convergence condition is met, thereby generating a final score vector compatible for all nodes out of the plurality of processing nodes and informative of one or more average similarity scores, each associated with a respective subject out of the plurality of subjects, wherein at least one node out of the plurality of processing nodes associates the face image with the subject that corresponds to the highest score in the node's final score vector.

In accordance with certain other aspects of the presently disclosed subject matter, there is provided a non-transitory storage medium comprising instructions embodied therein, that when executed by a processor comprised in a processing node operatively interconnected to a plurality of processing nodes, cause the processor to perform a method of associating a face image with a subject out of a plurality of subjects. The method comprises obtaining at least part of the face image and extracting features of the obtained at least part of the face image thereby generating a feature template comprising the extracted features, the features extracted by any given node being different than the features extracted by at least one other node. The method further comprises comparing the feature template generated by the node with each subject template out of a plurality of subject templates stored in the node, each stored subject template comprising features of a corresponding at least part of a face image of a different subject out of the plurality of subjects, and calculating an initial similarity score in respect of each comparison, thereby generating an initial score vector informative of a plurality of initial similarity scores associated with a respective plurality of subjects. The method further comprises averaging the initial similarity score vectors generated by the node and by at least two predefined nodes out of the plurality of processing nodes, thereby giving rise to an intermediate similarity score vector. The method further comprises repeatedly averaging the intermediate similarity score vectors generated by the node and by the at least two predefined nodes until a convergence condition is met, thereby generating a final score vector compatible for all nodes out of the plurality of processing nodes and informative of one or more average similarity scores, each associated with a respective subject out of the plurality of subjects. The method further comprises associating the face image with the subject that corresponds to the highest score in the node's final score vector.

In accordance with certain other aspects of the presently disclosed subject matter, there is provided a method of recognizing a subject out of a plurality of subjects as corresponding to a captured face image, the recognizing provided using at least one source node (SN) and a plurality of recognizer nodes (RN) operatively coupled to the SN, each RN associated with at least one face module (FM) of a plurality of FMs. The method comprises extracting, by the SN, from the captured face image a plurality of FM images corresponding to the plurality of FMs, and transferring the extracted FM images to the plurality of RNs, wherein a given FM image is transferred to at least one RN associated with the FM corresponding to the given FM image, and wherein each RN receives at least one FM image. The method further comprises, for each given FM image, at one or more RNs: extracting at least a subset of FM features from the received FM image, thereby generating a FM template comprising features of the FM image; comparing the generated FM template to a plurality of templates stored at the RN, each stored template associated with the corresponding FM of a respective subject out of the plurality of subjects; generating a similarity score in respect of one or more subjects out of the plurality of subjects, the similarity score generated in respect of a given subject being indicative of a similarity measure between the FM template and a stored template associated with the given subject; for at least part of the plurality of subjects, averaging, by the plurality of RNs, similarity scores generated by different RNs in respect of the same subject, thereby giving rise to a plurality of average similarity scores each associated with a respective subject of the at least part of the plurality of subjects; and determining, by at least one RN, the subject corresponding to the captured face image as the subject having the highest averaged score out of the plurality of average similarity scores.

In accordance with further aspects of the presently disclosed subject matter, and optionally in combination with other aspects, obtaining at least part of the face image can comprise obtaining one or more face module images extracted from the face image, each face module image associated with a respective face module. The one or more face module images obtained by any given node can be different than the one or more face module images obtained by at least one other node. Each node can be associated with a given one or more face modules, and each node can obtain the one or more face module images associated with the node's associated one or more face modules. At least two nodes can be associated with the same one or more face modules, and each of the at least two nodes can extract features of the obtained one or more face module images using a plurality of feature extractors stored in the node, wherein the plurality of feature extractors stored in a first one of the at least two nodes can be different than the plurality of feature extractors stored in a second one of the at least two nodes. The first one of the at least two nodes can have stored therein a first plurality of subject templates and the second one of the at least two nodes can have stored therein a second plurality of subject templates different from the first plurality of subject templates.

In accordance with further aspects of the presently disclosed subject matter, and optionally in combination with other aspects, averaging the intermediate similarity vectors can be performed in each iteration out of a plurality of iterations, and the convergence condition can be met upon the number of iterations reaching a predetermined threshold, or upon a difference between an intermediate score vector generated in the n^{th} iteration and the intermediate score vector generated in the (n-1)^{th} iteration being less than a predetermined threshold.

In accordance with further aspects of the presently disclosed subject matter, and optionally in combination with other aspects, the face image can be associated with the subject corresponding to the highest score when the highest score is above a predetermined threshold.

In accordance with further aspects of the presently disclosed subject matter, and optionally in combination with other aspects, averaging the initial similarity score vectors generated by a given node and at least two predefined nodes can comprise selecting the top n scores from each of the node and the at least two predefined nodes and averaging the selected scores.

Among advantages of certain embodiments of the presently disclosed subject matter is non-centralized distributed processing and decision taking. That is, each recognizer node is capable of fusing the generated scores and taking a recognition decision. As such, the susceptibility of the distributed system can be significantly reduced by eliminating the need for sink nodes.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a schematic network diagram of a distributed face recognition system as known in the prior art;

FIG. 2 illustrates a schematic network diagram of a distributed face recognition system in accordance with certain embodiments of the presently disclosed subject matter;

FIG. 3A illustrates a generalized functional diagram of a distributed face recognition system in accordance with certain embodiments of the presently disclosed subject matter;

FIG. 3B illustrates a generalized functional diagram of a registration unit of a distributed face recognition system in accordance with certain embodiments of the presently disclosed subject matter;

FIG. 3C illustrates a generalized functional diagram of a source node of a distributed face recognition system in accordance with certain embodiments of the presently disclosed subject matter;

FIG. 3D illustrates a generalized functional diagram of a recognizer node of a distributed face recognition system in accordance with certain embodiments of the presently disclosed subject matter;

FIG. 4 illustrates a generalized flow chart of enrolling subjects in accordance with certain embodiments of the presently disclosed subject matter;

FIG. 5 schematically illustrates generating a set of feature extractors in accordance with certain embodiments of the presently disclosed subject matter;

FIG. 6 schematically illustrates generating reference templates in accordance with certain embodiments of the presently disclosed subject matter;

FIGS. 7A-7C schematically illustrate transferring feature extractors to recognizer nodes in accordance with certain embodiments of the presently disclosed subject matter;

FIGS. 8A-8D schematically illustrate transferring reference templates to recognizer nodes in accordance with certain embodiments of the presently disclosed subject matter;

FIG. 8E schematically illustrates transferring feature extractor subset—template subset pairs to recognizer nodes in accordance with certain embodiments of the presently disclosed subject matter;

FIG. 9 schematically illustrates subjects associated with reference templates in accordance with certain embodiments of the presently disclosed subject matter;

FIG. 10 illustrates a generalized flow chart of recognizing a subject in accordance with certain embodiments of the presently disclosed subject matter;

FIGS. 11A-11B illustrate a score vector in accordance with certain embodiments of the presently disclosed subject matter;

FIG. 12 illustrates a non-limiting example of averaging in accordance with certain embodiments of the presently disclosed subject matter; and

FIG. 13 illustrates a non-limiting example of averaging score vectors, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “calculating”, “associating”, “comparing”, “generating”, “averaging”, “matching”, “obtaining”, “extracting” or the like, refer to the action(s) and/or process(es) of a computer that manipulate and/or transform data into other data, said data represented as physical, such as electronic, quantities and/or said data representing the physical objects. The term “computer” should be expansively construed to cover any kind of electronic device with data processing capabilities including, by way of non-limiting example, processing nodes disclosed in the present application.

It is to be understood that the term “non-transitory computer usable medium” is used herein to exclude transitory, propagating signals, but to include, otherwise, any volatile or non-volatile computer memory technology suitable to the presently disclosed subject matter.

It is also to be understood that the term “signal” used herein excludes transitory propagating signals, but includes any other signal suitable to the presently disclosed subject matter.

The operations in accordance with the teachings herein may be performed by a computer specially constructed for the desired purposes or by a general-purpose computer specially configured for the desired purpose by a computer program stored in a computer readable storage medium.

Embodiments of the presently disclosed subject matter are not described with reference to any particular programming language. It will be appreciated that a variety of programming languages may be used to implement the teachings of the presently disclosed subject matter as described herein.

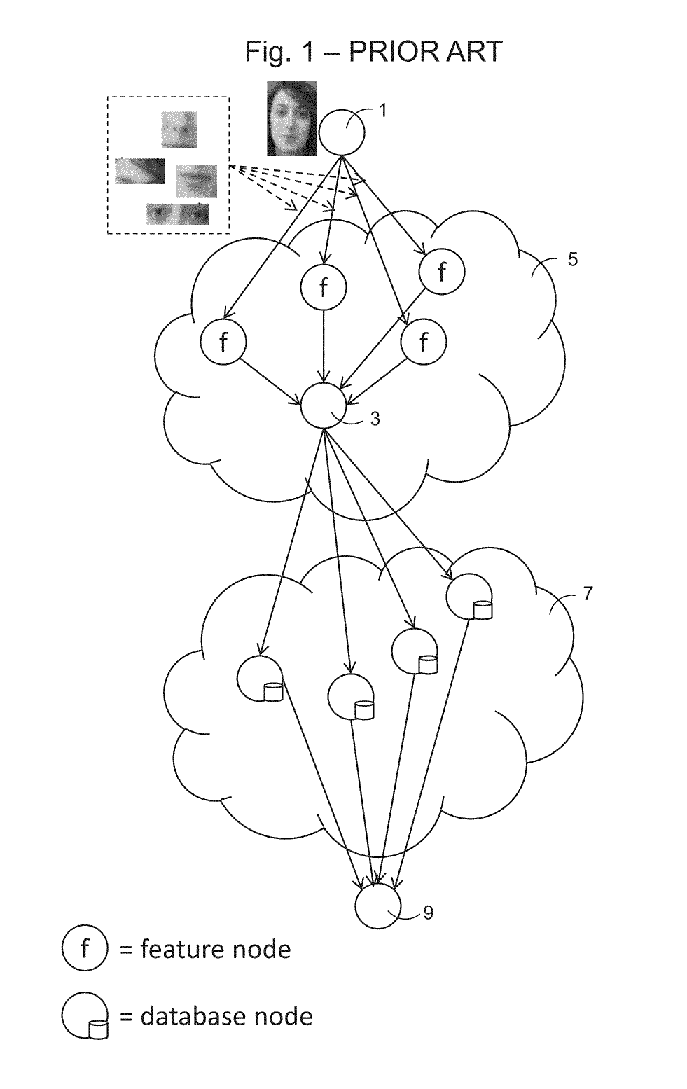

FIG. 1 illustrates a schematic network diagram of a distributed face recognition system according to the prior art (see, e.g. Yan and Osadciw cited in the background). The prior art face recognition system includes a feature net (5) and a database net (7), each of which include a plurality of processing nodes. In a setup phase, features used for classifying the various face modules are distributed between the feature net (5) nodes, such that each node has stored therein one or several features used to process each face module. Database templates of known subjects are distributed between the database net (7) nodes, such that each database node has stored therein one or several database templates. In the recognition phase, a source node (1) obtains a face image and broadcasts each face module to the feature net (5) nodes for processing in parallel according to each node's stored features, whereby each node processes a subset of features of each face module. The results of each feature net (5) node processing are provided to a feature sink node (3), which aggregates the processed features, processed by individual nodes, and generates a complete face template to use as a query template. Sink node (3) also acts as a gateway to the database net (7), and broadcasts the query template to the database nodes. Each database node compares the query template with each of its own stored database template, and generates a similarity score in respect of each stored template. Optionally each database node can also generate a list of its top n candidates based on its own generated scores. Each database node's scores or candidate lists are provided to a database sink node (9) which fuses the scores or the candidate lists, as the case may be, and takes a final decision in respect of the matching subject.

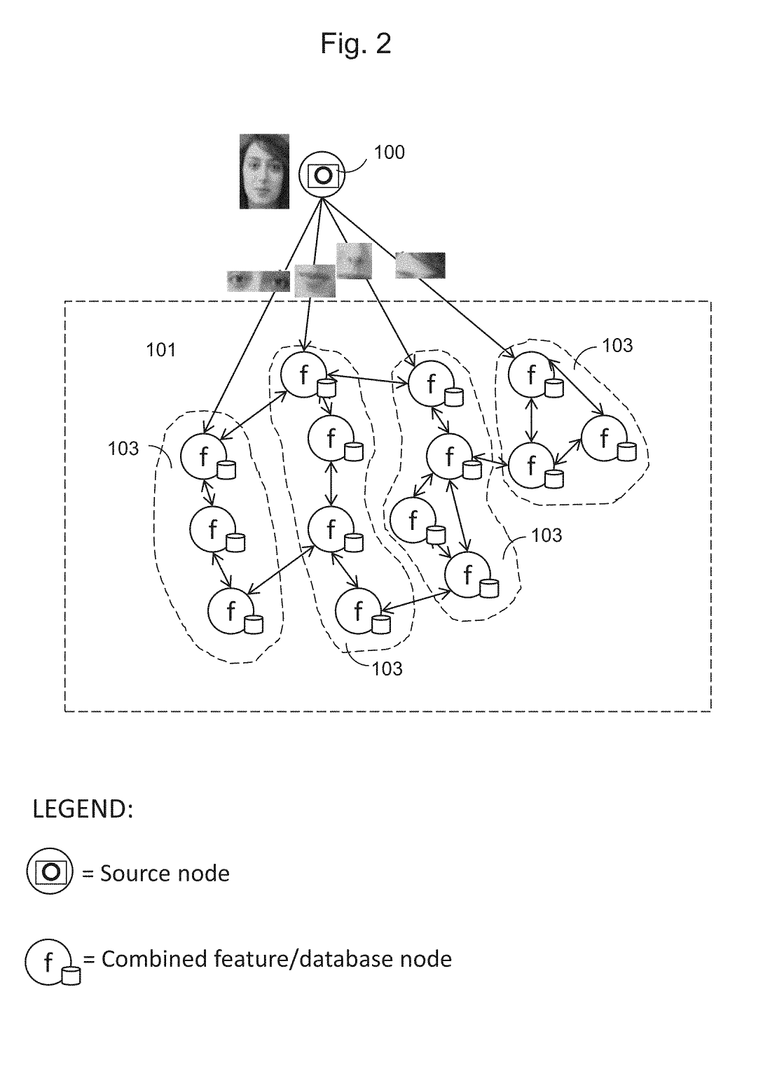

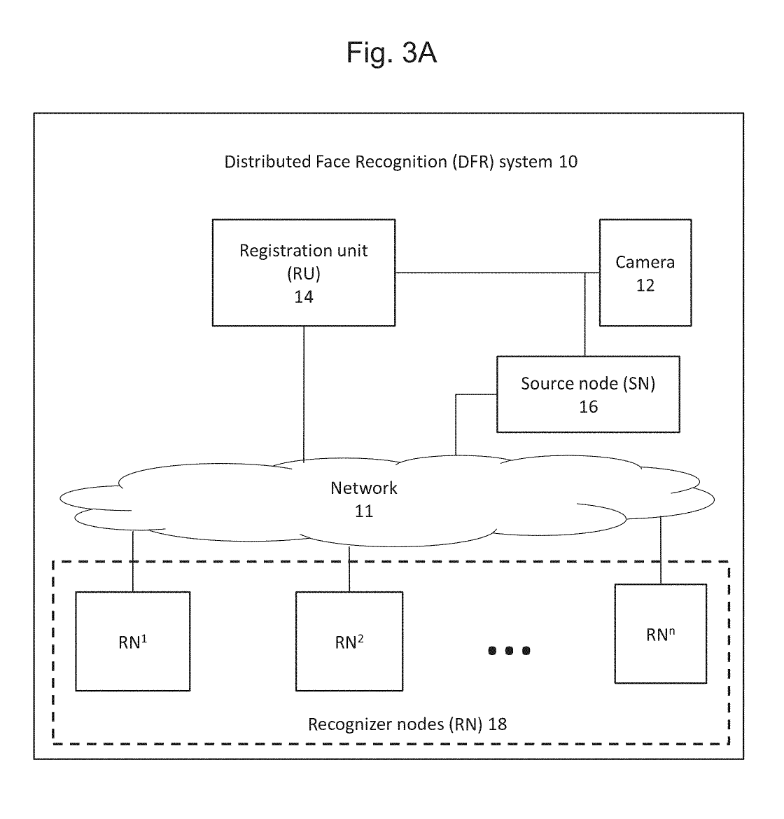

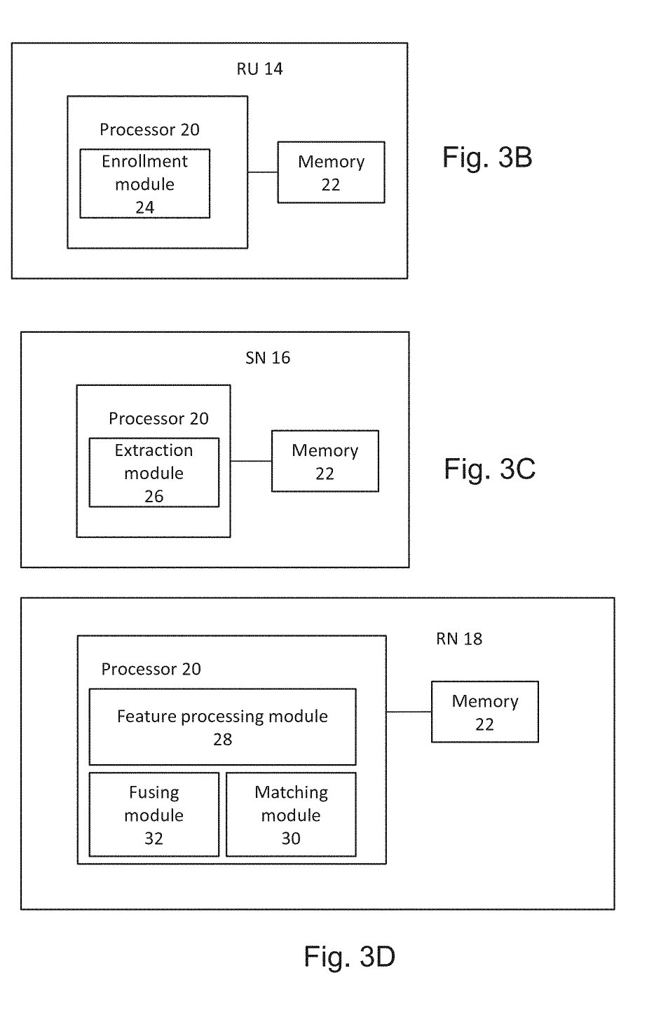

FIG. 2 illustrates a schematic network diagram of a distributed face recognition (DFR) system in accordance with certain embodiments of the presently disclosed subject matter. As will be further detailed with reference to FIGS. 3A-3D, the illustrated network comprises at least one source node (SN) (100) operatively connected to a plurality of recognizer nodes (RN) (101), each RN configured to performing feature processing and template matching of one or more predefined face modules. As shown in FIG. 2, the RNs (101) can be logically grouped into RN clusters (103), whereby each RN cluster (103) is configured to process one or more predefined face modules. By way of non-limiting example, a first RN cluster can process e.g. an eyes face module, a second cluster e.g. a mouth module, a third cluster e.g. a nose module, and a fourth cluster e.g. a forehead module. As will be detailed below, a decision with respect to the matching subject can be taken by any one or more RNs. As will further be apparent from the following description, within a RN cluster, the different RNs can process different subsets of features of the given face module, and can perform database matching using different subsets of the database.

In the description that follows, reference may be made to an action or process which is taken or performed by a RN cluster. Such references should be understood to mean that the indicated action or process is taken or performed by each RN in the cluster.

It will be appreciated by those skilled in the art that the network schematic diagram shown in FIG. 2 is but a single non-limiting example and is not to be understood as in any way limiting the disclosed subject matter to the illustrated network schematic.

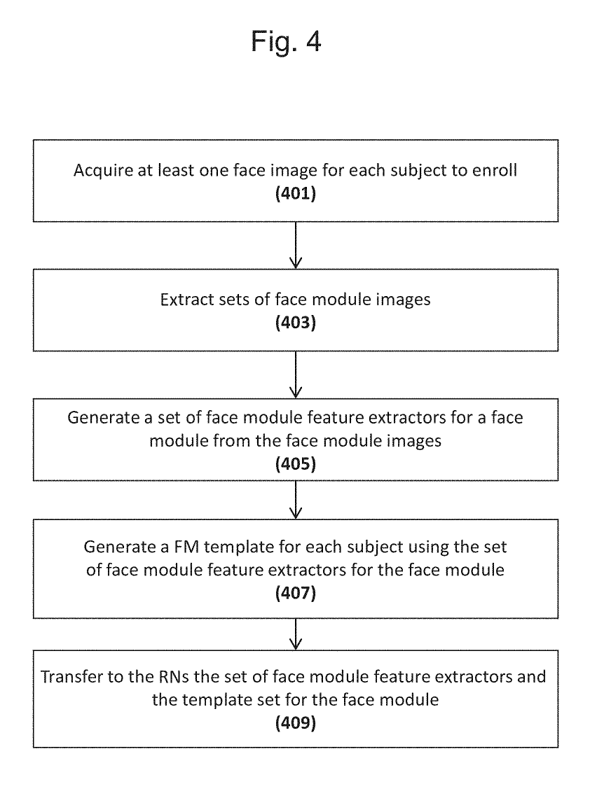

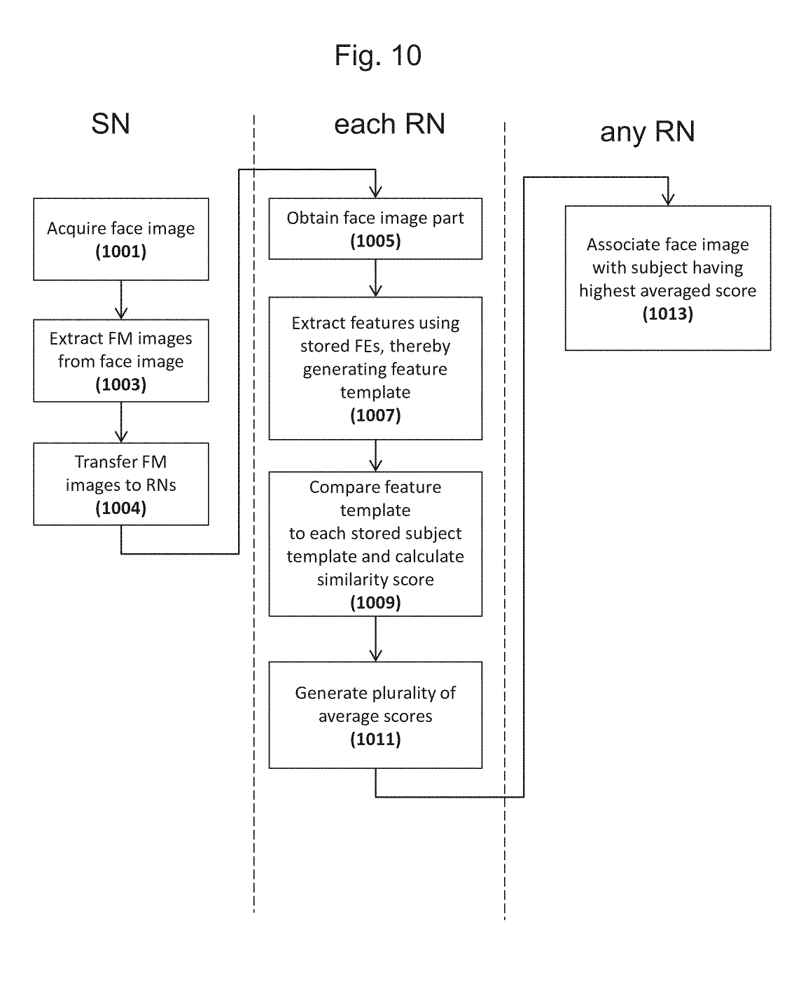

FIG. 3A illustrates a generalized functional diagram of a DFR system (10) in accordance with certain embodiments of the disclosed subject matter. The illustrated DFR system (10) comprises a plurality of operatively interconnected processing nodes (18) (referred to hereinafter also as recognizer nodes (RNs)) configured to process one or more extracted face module images, as will further be detailed with reference to FIG. 10, and a wired, wireless, or combined wired and wireless data communications network (11) operatively interconnecting the nodes. The illustrated DFR system further comprises a camera (12) (or other image capture device) configured to capture face images, and a registration unit (RU) (14) operatively coupled to network (11) and configured to enrol subjects in the DFR system using subjects' face images, as will be further detailed below with reference to FIG. 4. The illustrated DFR system further comprises a source node (SN) (16) operatively coupled to network (11) and configured to extract face module images from a face image to recognize, e.g. a face image captured by camera (12), and to transfer the extracted face module images to RNs (18), e.g. via network (11), as will further be detailed with reference to FIG. 10.

In certain embodiments, camera (12) can be part of RU (14) and/or SN (16). In certain embodiments, RU (14) can be part of SN (16) or part of one or more RNs (18). In certain embodiments, one or more RNs (18) can perform the functions of SN (16). That is, SN (16) need not be a dedicated node; a single node can perform the dual functions of a RN and SN. In certain embodiments, each RN (18) is operatively coupled, e.g. via network (11), to at least two other RNs (hereinafter referred to as “neighbour nodes” or “neighbour RNs”) as detailed below.

FIG. 3B illustrates a generalized functional diagram of a RU (14). RU (14) comprises a processor (20) operatively coupled to a memory (22). Processor (20) of RU (14) can be configured to execute one or several functional modules in accordance with computer-readable instructions implemented on a non-transitory computer usable medium, such as the illustrated memory (22). Such functional modules are referred to hereinafter as comprised in the processor. In certain embodiments, processor (20) of RU (14) comprises an enrolment module (24) configured to enrol subjects in the DFR system (10), as will be further detailed with reference to FIG. 4.

FIG. 3C illustrates a generalized functional diagram of a SN (16). SN (16) comprises a processor (20) operatively coupled to a memory (22). Processor (20) of SN (16) can be configured to execute one or several functional modules in accordance with computer-readable instructions implemented on a non-transitory computer usable medium, such as the illustrated memory (22). Such functional modules are referred to hereinafter as comprised in the processor. In certain embodiments, processor (20) of SN (16) comprises an extraction module (26) configured to extract face modules from a face image, as will be further detailed with reference to FIG. 10.

FIG. 3D illustrates a generalized functional diagram of a RN (18). RN (18) comprises a processor (20) operatively coupled to a memory (22). Processor (20) of RN (18) can be configured to execute one or several functional modules in accordance with computer-readable instructions implemented on a non-transitory computer usable medium, such as the illustrated memory (22). Such functional modules are referred to hereinafter as comprised in the processor. In certain embodiments, processor (20) of RN (18) comprises a feature processing module (28) configured to generate a feature template, a matching module (30) configured to compare two templates and generate a similarity score indicative of a similarity measure, and a fusing module (32) configured to fuse the similarity scores generated by different nodes in respect of the same subject using distributed averaging, as will be further detailed with reference to FIG. 10.

As illustrated in FIG. 3B, in certain embodiments, processor (20) of RU (14) comprises an enrolment module (24) configured to enrol subjects in the DFR system (10). In certain embodiments, processor (20) of SN (16) comprises at least an extraction module (26) configured to extract face modules from a face image. In certain embodiments, processor (20) of RN (18) comprises at least a feature processing module (28) configured to generate a feature template, a matching module (30) configured to compare two templates and generate a similarity score indicative of a similarity measure, and a fusing module (32) configured to fuse the similarity scores generated by different nodes in respect of the same subject using distributed averaging.

It is noted that the teachings of the presently disclosed subject matter are not bound by the DFR system described with reference to FIGS. 2, 3A-3D. Equivalent and/or modified functionality can be consolidated or divided in another manner and can be implemented in any appropriate combination of software, firmware and hardware and executed on a suitable device. The network of the DFR system can be a standalone network, or integrated, fully or partly, with other networks. Each component of the DFR system can be a standalone component, or integrated, fully or partly, with other components.

The operation of DFR system (10) will now be detailed, in accordance with certain embodiments, with reference to FIGS. 4-10. The operation can be divided into two main processes: enrolment and recognition. As discussed above, enrolment refers to the process of enrolling subjects in the DFR system for subsequent facial recognition. As used herein, a “subject” is a person to be identified, among the persons in the database, based on facial recognition. By way of non-limiting example, a subject can be a person requesting access to a secured facility protected by the disclosed DFR system. Subjects for whom access is to be granted must be enrolled prior to their requesting such access. Recognition refers to identifying a face in a new face image as associated with a particular enrolled subject.

Referring now to FIG. 4, there is illustrated a generalized flow chart of enrolling subjects, in accordance with certain embodiments. Using camera (12), RU (14) acquires (401), captures, or otherwise obtains a plurality of face images associated with a respective plurality of subjects to enrol, each face image associated with a given subject out of the plurality of subjects to enrol. RU (14) acquires at least one face image per subject. As used herein, “face image” includes data representative of a face image, and data informative of a face image. Optionally, RU (14) can also acquire additional data, such as, e.g., each subject's personal details, access permissions, etc.

RU (14), e.g. enrolment module (24), extracts (403), from the plurality of face images, a plurality of sets of face module images (“FM images”), and associates each extracted set of FM images with a particular subject. As used herein, a “FM image” should be expansively construed to cover a part of a face image in which is depicted a particular face module of a predetermined group of face modules (e.g. eyes, ears, nose, mouth, etc.). Upon FM image extraction (403), each subject is associated with r FM images, where r is the number of distinct face modules in the predetermined group of face modules. By way of non-limiting example, the predetermined group of face modules can include, e.g., the eyes, nose, mouth and forehead, in which case RU (14) extracts an eyes image, nose image, mouth image and forehead image for each subject (r=4). FM images can be extracted from face images using known detection algorithms, e.g. Viola-Jones. Other extraction methods are known to persons skilled in the art.

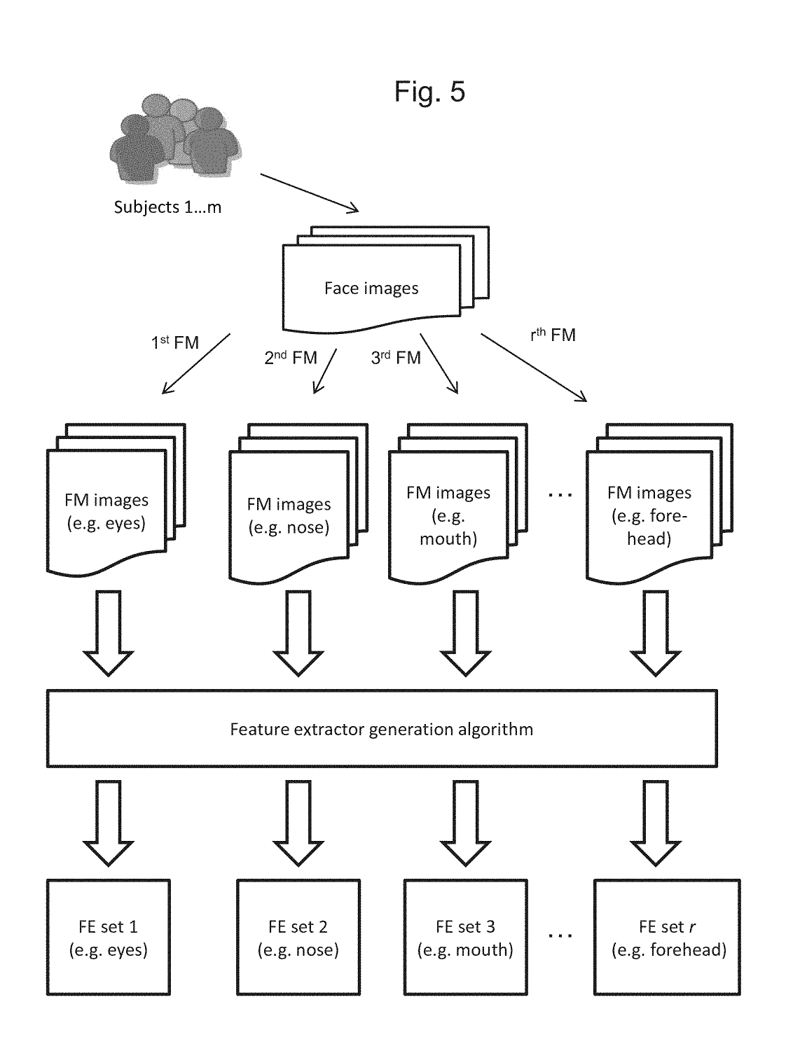

RU (14), e.g. enrolment module (24), generates (405), for a given face module in the predetermined group of face modules, a set of k feature extractors (“FE set”) corresponding to the given face module using one or more known algorithms capable of generating a set of feature extractors from a group of images, as illustrated in FIG. 5. Non-limiting examples of such algorithms include, e.g. Principle Component Analysis (PCA), Linear Discriminant Analysis (LDA), etc., which can generate, from a set of training images of the face module, a set of subspace vectors defining a face module subspace. Features of any given face module image from the training set can then be extracted by projecting the given face module image onto the face module subspace. It should be noted that set of subspace vectors which are “learned” from the training set of face module images can also be used to extract features of a face module image which are not part of the training set (e.g. a new face module image depicting the face model of an enrolled subject, as will be detailed below with reference to FIG. 10). The set of subspace vectors usable for extracting features of a face module image is an example of the FE set referred to herein. As used herein, a given FE set is associated with a given face module of the group of face modules.

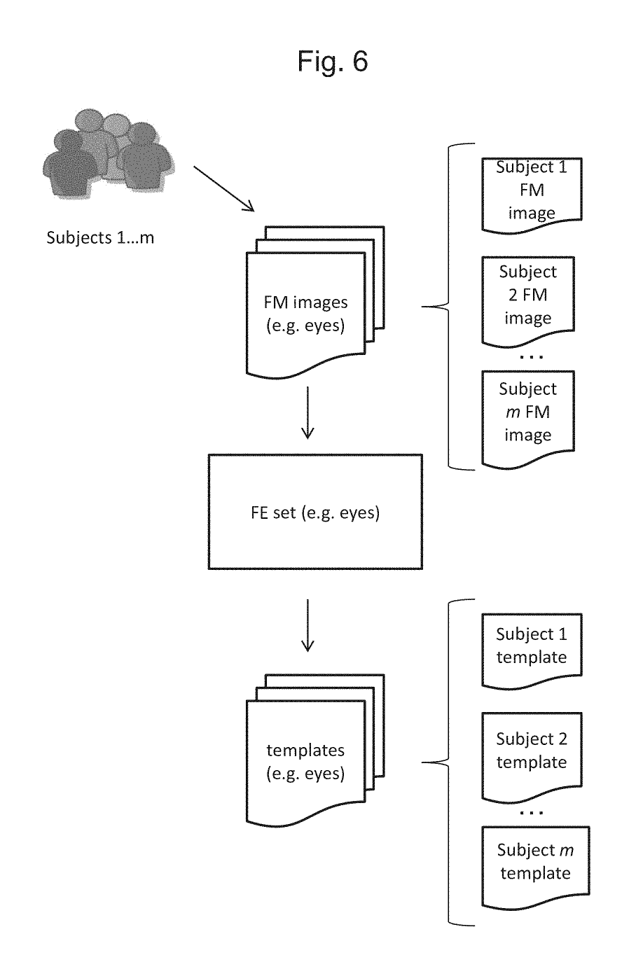

Using the FE set for a given face module, RU (14), e.g. enrolment module (24), generates (407), for the given face module, a set of face module templates (“template set”), each face module template associated with a given subject out of the plurality of subjects, and each template comprises features of the associated subject's given face module. In certain embodiments, for a given face module, one face module template can be generated for each subject. In certain other embodiments, for a given face module, more than one face module template can be generated for one or more subjects. Each template is generated by extracting face module features from the associated subject's FM image using the FE set, thereby generating a template comprising the extracted face module features, as depicted in FIG. 6. For example, as detailed above, for a given FM image depicting a given face module, a template can be generated by projecting the FM image onto the subspace vectors defining the face module subspace of the given face module as learned from the set of training images depicting the given face module. Each generated face module template associated with a subject is hereinafter referred to as a “subject template”, and the set of all m subjects' face module templates for a given face module is referred to as a “template set”, where m denotes the number of enrolled subjects. As used herein, each template set is associated with a given one or more face modules of the predetermined group of r face modules.

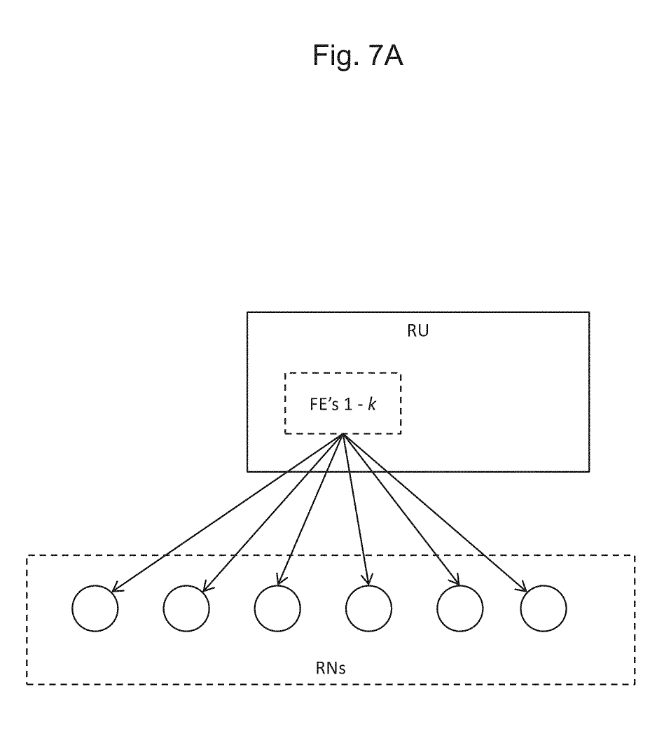

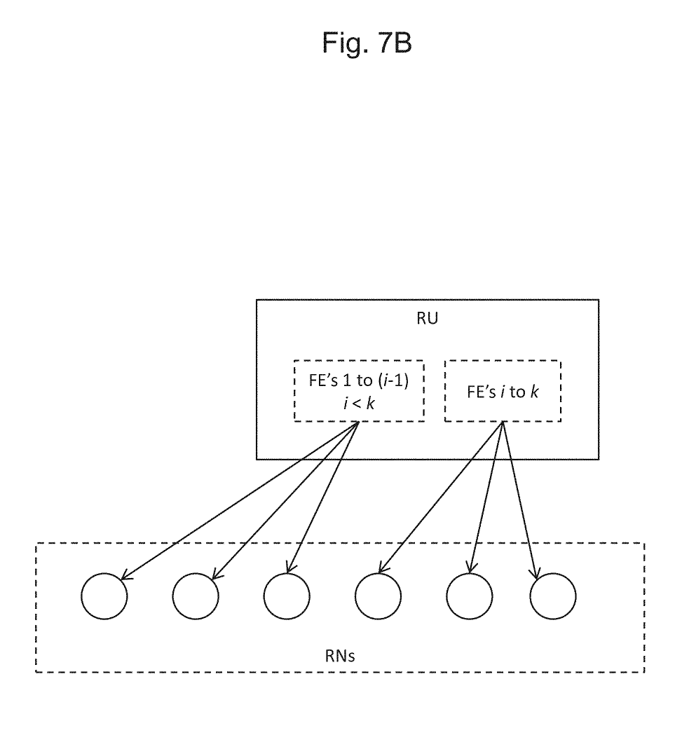

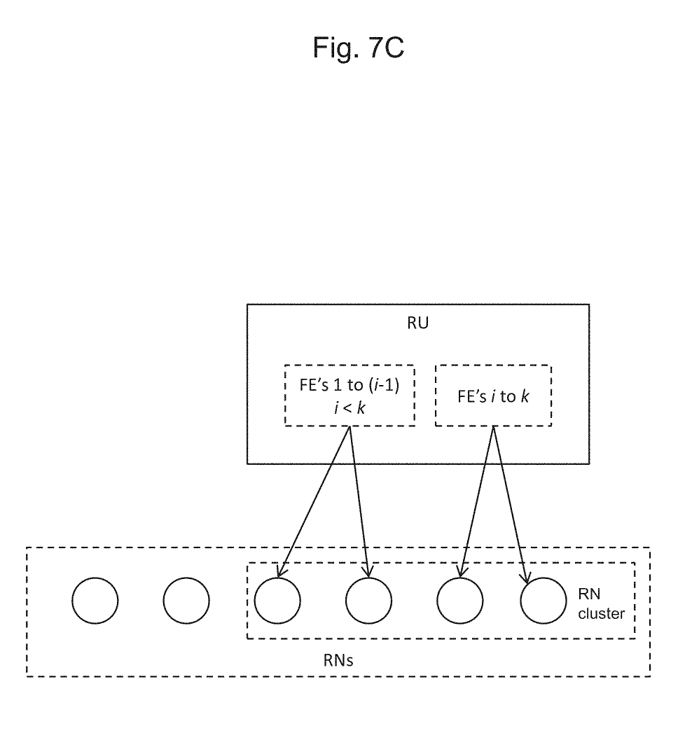

RU (14), e.g. enrolment module (24), transfers (409) to the RNs the generated FE set and the generated template set for the given face module. In certain embodiments, each RN can be transferred the entire FE set, as depicted in FIG. 7A. In certain other embodiments, each RN can be transferred a subset of the FE set, as depicted in FIG. 7B. In certain other embodiments, a given RN cluster, being a predetermined subset of RNs, can be transferred the entire FE set such that each RN in the cluster is transferred a subset of the entire FE set, as depicted in FIG. 7C.

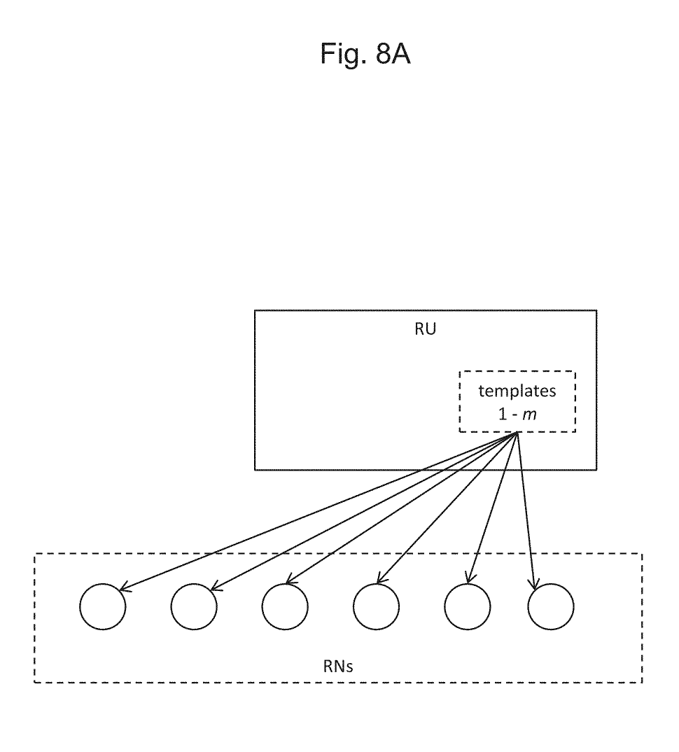

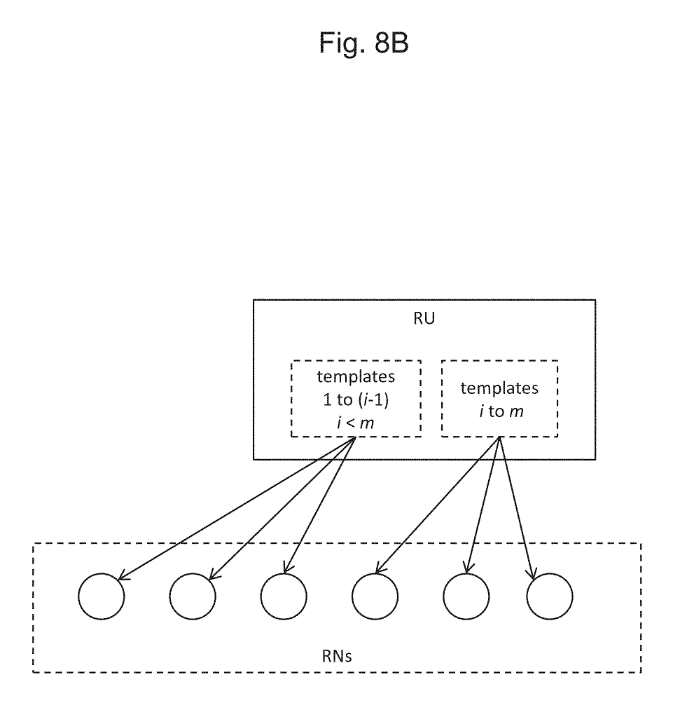

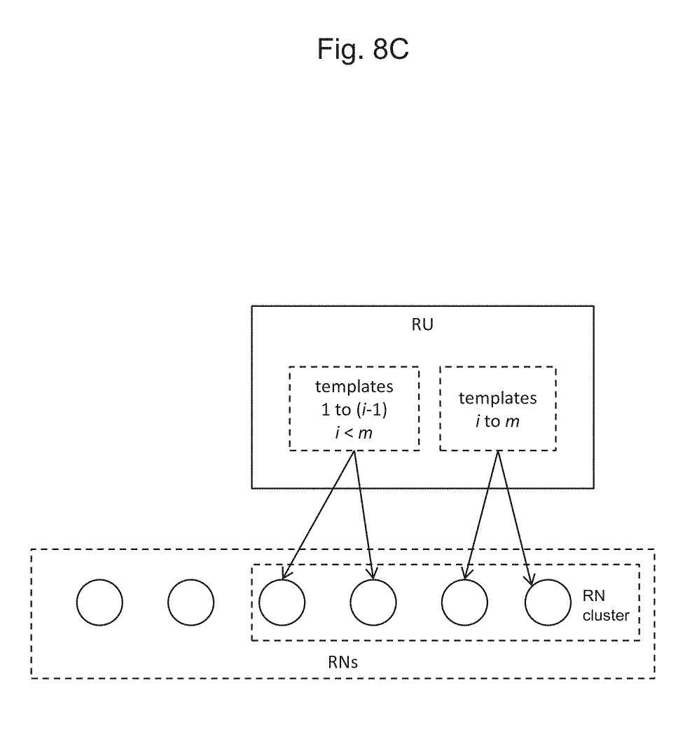

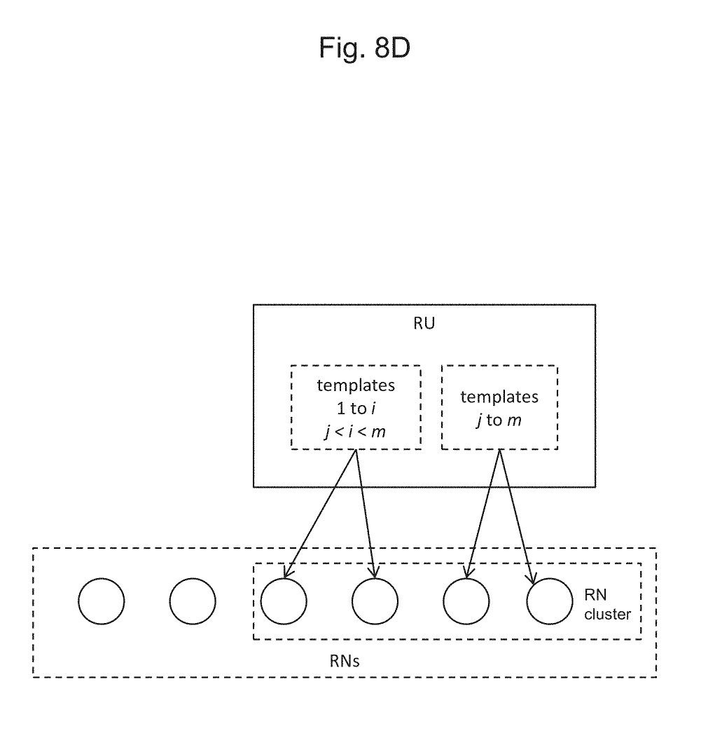

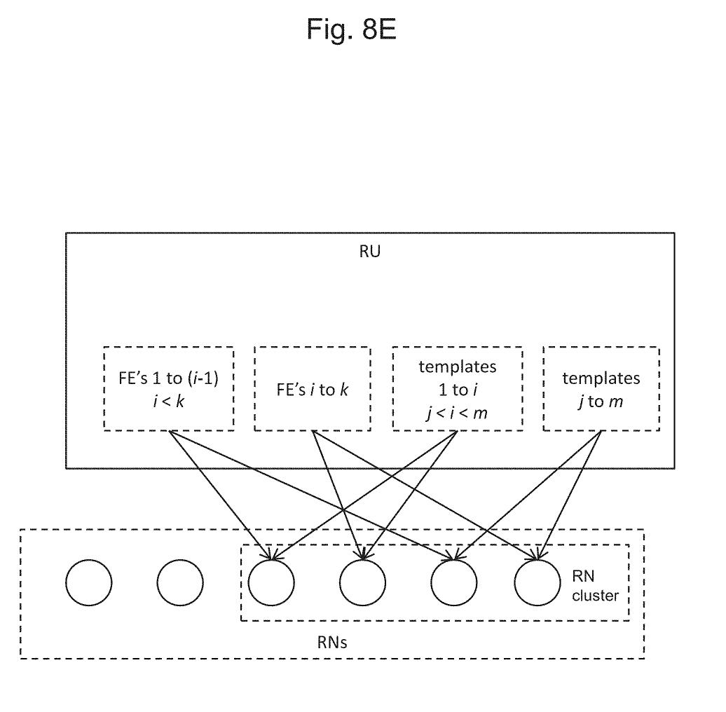

In certain embodiments, each RN can be transferred the entire template set for the given face module, as depicted in FIG. 8A. In certain other embodiments, each RN can be transferred a subset of the template set, as depicted in FIG. 8B. In certain other embodiments, a given RN cluster can be transferred the entire template set such that each RN in the cluster is transferred a subset of the entire template set, as depicted in FIG. 8C. In certain embodiments, each RN in the RN cluster can be transferred at least partially overlapping subsets of the entire template set, as depicted in FIG. 8D.

In certain embodiments, predefined RN clusters can be associated with predefined face modules of the group of face modules, i.e. each RN cluster is configured to process features of one or more predefined face modules out of the group of all face modules. By way of non-limiting example, assuming the group of face modules contains eyes, mouth, nose and forehead, a first RN cluster can be configured to process, e.g., the eyes and forehead, while a second RN cluster can be configured to process, e.g., the nose, and a third RN cluster can be configured to process, e.g., the mouth. In cases where each RN cluster is associated with one or more predefined face modules, RU (14) transfers to each RN in a given cluster all or part of the FE set(s) corresponding to the RN's associated face module(s), and all or part of the template set(s) corresponding to the RN's associated face module. For e.g. RU (14) can be preconfigured with, or to access, a database providing the network address of each RN and the associated predefined face module(s) of each RN (hereinafter the database is referred to as the “RN-FM mapping”). In certain embodiments, for one or more given RN clusters, RU (14) transfers to each RN in the given cluster a subset of the FE set corresponding to the associated one or more face modules and a subset of the template set generated in respect of the associated one or more face modules. In certain embodiments, each RN in the cluster stores therein a different FE subset—template subset pair, as depicted for a single RN cluster in FIG. 8E.

In certain embodiments, each RN stores therein the feature extractors and subject templates transferred to the RN.

The feature extractor generation (405), template generation (407) and transferring (409) detailed above are provided for each face module in the predetermined group of face modules, as illustrated in FIG. 5. In certain embodiments, the transferring of FE sets, associated with respective face modules, to the RNs can be performed such that each RN is transferred at least a subset of each FE set, thereby enabling each RN to process at least some features of each face module, as will be detailed below with reference to FIG. 10. In certain other embodiments, the transferring can be performed such that each RN is transferred at least a subset of at least one FE set associated with a respective at least one face module, thereby enabling each RN to process at least some features of at least one face module, as will be detailed below with reference to FIG. 10.

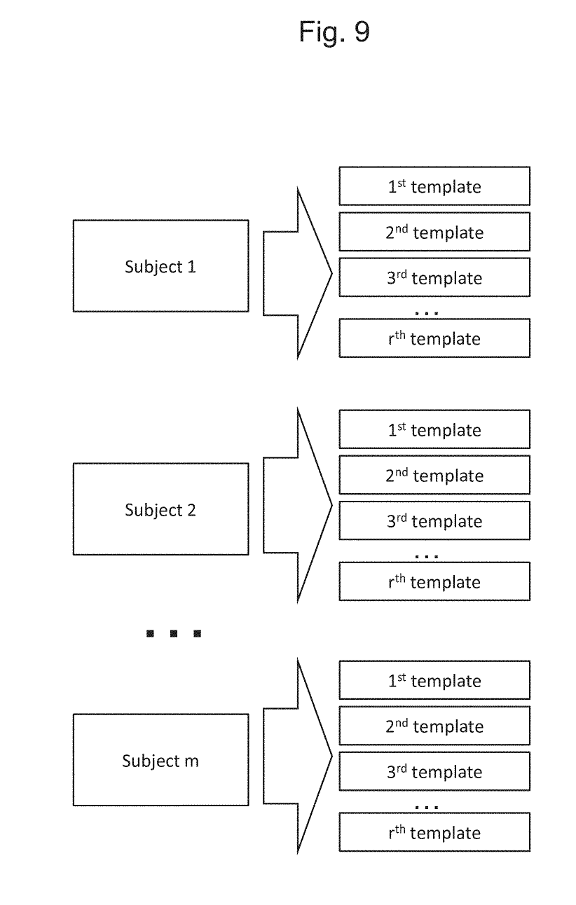

Upon completion of subject enrolment, each enrolled subject is associated with at least one set of r templates, as depicted in FIG. 9. For example, assuming the face modules are the eyes, mouth, nose and forehead, each subject is associated with an “eyes” template, a mouth template, a nose template and forehead template, each given template comprising features of the given face module of the associated subject. In certain embodiments, a given one or more enrolled subjects can also each be associated with more than one set of templates. The DFR system is now ready to associate a new face image with a given enrolled subject (also referred to herein as “recognizing a subject”), as will be detailed below.

FIG. 10 illustrates a generalized flow chart of recognizing a subject, in accordance with certain embodiments. SN (16) acquires (1001), captures, or otherwise obtains a new face image depicting the face of a person, e.g. an enrolled subject, e.g. using camera (12) (which could be the same or different camera used for enrolment). In certain embodiments, SN (16) can pre-process the acquired face image, such as by performing one or more of segmentation, normalization, histogram equalization, geometric alignment etc.

Executing extraction module (26), SN (16) extracts (1003) FM images from the obtained face image, using known face module extraction algorithms (e.g. Viola-Jones), and transfers (1004) the extracted FM images to the RNs for processing. In certain embodiments, as detailed above with reference to FIG. 4, each RN has stored therein (as a result of transferring (409)) at least a subset of the FE set associated with each face module and at least a subset of the template set associated with each face module, in which case SN (16) can transfer any FM image to any one or more RNs for further processing.

In certain other embodiments, as detailed above with reference to FIG. 4, each RN is associated with a given one or more predefined face modules, and has stored therein (as a result of transferring (409)) at least a subset of the FE set of the associated one or more predefined face modules, and at least a subset of the template set of the associated one or more predefined face modules. In that case, SN (16) can be preconfigured with, or to access, the RN-FM mapping containing data indicative of each RN's associated face module(s). SN (16) then transfers (1004) to each RN the FM image(s) corresponding to the RN's associated face module(s).

Upon transferring (1004), each RN (18) thereby obtains (1005) from SN (16) at least a part of the face image, being one or more FM images. In certain embodiments, each RN can process features of any face module, as detailed above with reference to FIG. 4, in which case each RN can obtain from SN (16) any FM image(s). In certain other embodiments, each RN is associated with one or more predefined face modules, as detailed above with reference to FIG. 4, in which case each RN obtains the FM image(s) corresponding to the RN's predefined face module(s).

Having obtained one or more FM images, each RN (18), e.g. using feature processing module (28), extracts (1007) features of the obtained FM image(s) using the RN's stored at least a subset of the FE set corresponding to the face module(s) depicted in the obtained FM image(s) and stored in the RN, as detailed above with reference to FIG. 4, thereby generating a feature template comprising the extracted features. In certain embodiments, each RN extracts different features than the features extracted by at least one other RN due to the RNs having stored therein different feature extractors (including, e.g. as part of the same FE set or a different FE set). In certain embodiments, each RN in a given RN cluster extracts different features than the features extracted by at least one another RN in the RN cluster. In certain embodiments, each RN in a given RN cluster extracts a different subset of features.

In certain embodiments, as detailed above with reference to FIG. 4, each RN (18) is associated with one or more predefined face modules, in which case each RN obtains only those FM images corresponding to the RN's associated face modules and extracts features of the obtained FM image(s) using the stored feature extractors obtained from RU (14) and corresponding to the associated face module(s). In certain other embodiments, as detailed above, each RN can process features of any of the face modules and thus can obtain any one or more FM images without prior knowledge of which FM image it obtains. In such cases, extraction (1007) can include preprocessing prior to the actual extraction, e.g. to detect the face module(s) depicted in the obtained image using known detection algorithms Depending on which face module is detected, the extraction (1007) is performed using the particular stored feature extractors which correspond to the detected face module(s).

Each RN (18), e.g. using matching module (30), compares (1009) the feature template it generated and which corresponds to a given one or more face module(s), to each subject template out of a plurality of subject templates stored in the RN and which correspond to the given one or more face modules, and calculates an initial similarity score in respect of each comparison, thereby calculating a plurality of initial similarity scores associated with a plurality of subjects, each score associated with a subject. Each initial similarity score is indicative of a similarity measure between the feature template and the compared subject template, each subject template corresponding to a given enrolled subject. The higher the similarity measure, the higher the similarity score, and vice versa. As detailed above with reference to FIGS. 4, and 8B-8E, in certain embodiments, each RN has stored therein only a subset of the full template set corresponding to a given face module. In such cases, a similarity score is calculated in respect of certain subjects but not all subjects. Each RN thereby generates an initial score vector informative of the plurality of initial similarity scores calculated by the RN. As noted, each RN's initial score vector can comprise scores associated with a different plurality of subjects.

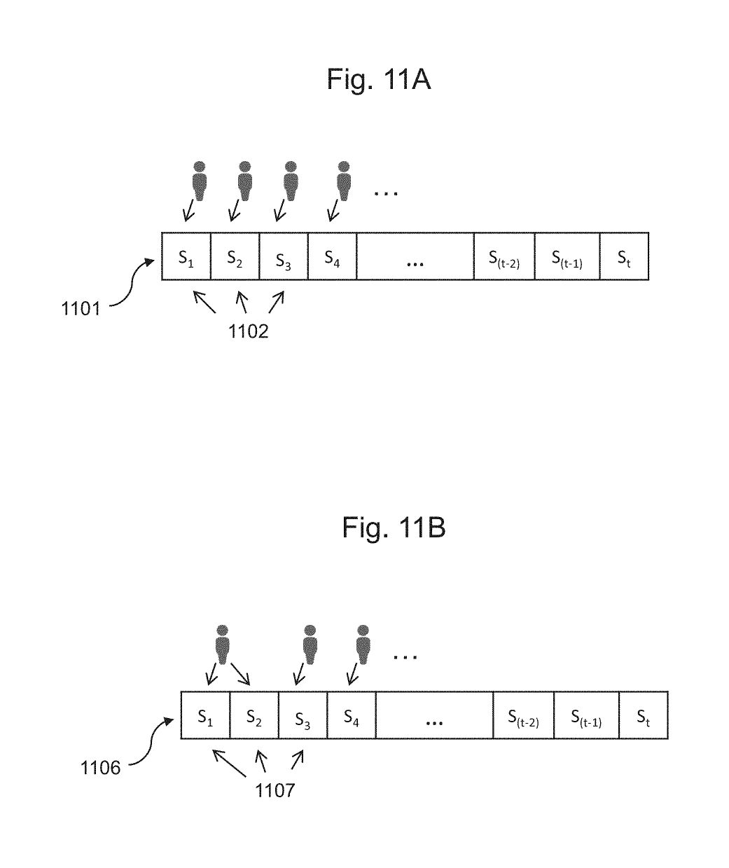

It is to be noted that, as detailed above with reference to FIG. 4, in certain embodiments a given subject can have more than one subject template (i.e. for a given face module). As such, in certain embodiments, each vector element can be associated with a different enrolled subject, while in certain other embodiments, two or more vector elements can be associated with the same enrolled subject. FIG. 11A illustrates a non-limiting example of a score vector (1101) in which each vector element (1102) is associated with a different subject. FIG. 11B illustrates a non-limiting example of a score vector (1106) in which, in respect of one or more given subjects, two or more vector elements (1107) can be associated with the same given subject.

A method of generating an initial similarity score will now be further detailed in accordance with certain embodiments. Assuming a subspace-based method is used for feature extraction and template generation, the face module image y can be vectorized and then projected to the module subspace to get a query template q comprising a vector of features. This vector can be compared to all stored vectors (templates) of enrolled subjects using, e.g., the Euclidean distance between the vectors or another distance metric. Each comparison will produce a scalar value. The inverse of the scalar can be used as the similarity score sᵢ, i=1, . . . , t as given by

$${s}_{i} = \frac{1}{1 + {‖ q - {f}_{i} ‖}^{2}} ,$$

where fᵢ is the i-th stored template. The score vector s^{(l)} will then contain all the similarity scores sᵢ, i=1, . . . , t, of the l-th RN, where l denotes the index of the particular RN and t denotes the number of subject templates stored in the RN. The scores at each RN are normalized and weighted.

Upon each RN having generated an initial score vector, each RN (18), e.g. using fusing module (32), generates (1011) a plurality of averaged scores associated with a respective plurality of subjects out of the enrolled subjects, thus giving rise to a locally stored compatible final score vector, each element associated with a given subject out of the enrolled subjects. Each of the plurality of averaged scores corresponds to an average initial score calculated by a plurality of RNs in respect of the same subject. As used herein, two or more final score vectors are “compatible” when although not necessarily identical, they convey the same meaning. More particularly, two final score vectors are compatible when, for any given subject, the subject's ranking as between the other subjects is the same in both vectors.

In certain embodiments, each RN generates its own compatible final score vector over a number of iterations using distributed averaging, as follows. In the first iteration, each RN averages the initial similarity score vectors generated by the RN and generated by each of at least two other predefined RNs (e.g. neighbour RNs) thereby generating, at each RN, an intermediate similarity score vector. In certain embodiments, in the first iteration, each RN selects the top n initial similarity scores generated by the RN and generated by each of at least two other predefined RNs (e.g. neighbour RNs) and averages the selected initial similarity scores, thereby generating, at each RN, an intermediate similarity score vector. In subsequent iterations, each RN repeatedly averages the intermediate similarity score vectors generated by the RN and generated by the at least two other predefined RNs until at least one convergence condition is met. Upon at least one convergence condition being met, the intermediate score vectors stored in the RNs become compatible final score vectors informative of a local approximation of the averaged initial similarity scores, each associated with a given subject out of the plurality of subjects.

In certain embodiments, the predefined nodes are the closest neighbor nodes (e.g. based on physical distance, logical distance, latency, etc.). In certain embodiments, the predefined nodes are determined according to predetermined rules.

In certain embodiments, a convergence condition is met upon the number of iterations meeting a predetermined threshold. In certain other embodiments, a convergence condition is met upon a delta (A) being below a predetermined threshold, the delta being the difference between the current score vector (e.g. the score vector generated in the n^{th} iteration) and the score vector of a previous iteration (e.g. the (n-1)^{th} iteration.

As detailed above, the initial similarity scores calculated by different RNs in respect of the same subject can be averaged, e.g. each node sharing its scores with at least two other nodes and distributedly averaging the shared scores over multiple iterations of sharing and averaging until a convergence condition is met. More particularly, in every iteration n in a plurality of iterations, RN^{(l)} shares its similarity scores s^{(l)}(n-1) with the scores of its p closest neighbouring RNs. For instance for p=2, RN^{(l)} receives the scores s^{(l-1)}(n-1), s^{(l+1)}(n-1) and averages them with its own so that the intermediate scores s^{(l)}(n) at node l are given by

$${s}^{( l )} ( n ) = \frac{{s}^{( l - 1 )} ( n - 1 ) + {s}^{( l )} ( n - 1 ) + {s}^{( l + 1 )} ( n - 1 )}{3} ,$$

In each iteration, each RN can share with its neighbour RNs either its entire plurality of initial scores, or only its top n scores. Sharing the top n scores only can be advantageous in certain embodiments, e.g., in order to limit the amount of data transmitted between the RNs in each iteration. After a number of iterations, the intermediate score vectors of each RN containing the averaged scores converge, and the rate of convergence can be calculated analytically. See, e.g., L. Xiao and S. Boyd. “Fast linear iterations for distributed averaging”, Systems & Control Letters, vol. 53, pp. 65-78 (2004), incorporated by reference herein.

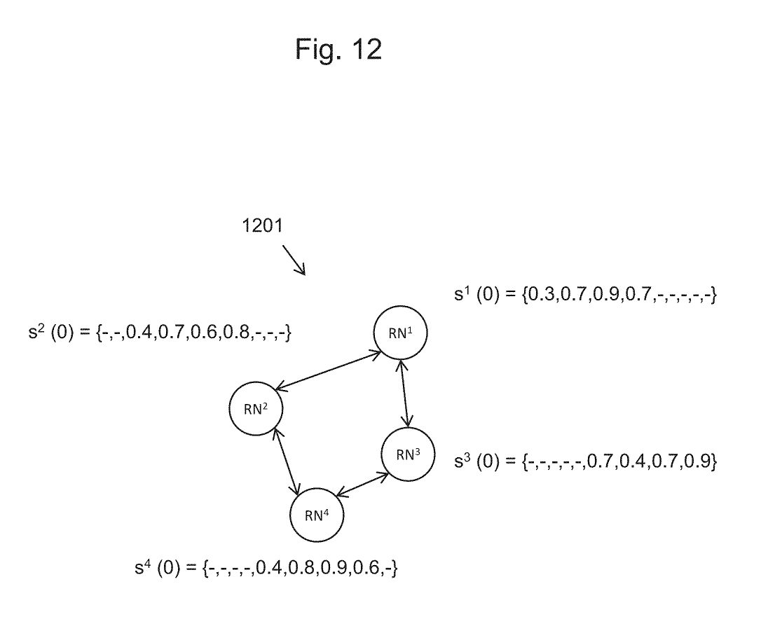

FIG. 12 illustrates by way of non-limiting example initial similarity score vectors generated by each of four (4) RNs marked RN¹, RN², RN³ and RN⁴ in respect of nine (9) subjects. Since the four RNs have stored therein different subsets of subject templates, some vector elements are empty and are not averaged. In each iteration, RN¹ exchanges scores with RN² and RN³; RN² exchanges scores with RN¹ and RN⁴; RN³ exchanges scores with RN¹ and RN⁴; and RN⁴ exchanges scores with RN² and RN³. Therefore, in the first averaging iteration:

1. RN¹ receives s²(0) and s³(0) and generates a first intermediate score vector:

s¹(1)=(s¹(0)+s²(0)+s³(0))÷3;

2. RN² receives s¹(0) and s⁴(0) and generates a first intermediate score vector:

s²(1)=(s²(0)+s¹(0)+s⁴(0))÷3;

3. RN³ receives s¹(0) and s⁴(0) and generates a first intermediate score vector:

s³(1)=(s³(0)+s¹(0)+s⁴(0))÷3; and

4. RN⁴ receives s²(0) and s³(0) and generates a first intermediate score vector:

s⁴(1)=(s⁴(0)+s²(0)+s³(0))÷3.

In the second iteration:

1. RN¹ receives s²(1) and s³(1) and generates a second intermediate score vector:

s¹(2)=(s¹(1)+s²(1)+s³(1))÷3;
2. RN² receives s¹(1) and s⁴(1) and generates a second intermediate score vector:

s²(2)=(s²(1)+s¹(1)+s⁴(1))÷3;

3. RN³ receives s¹(1) and s⁴(1) and generates a second intermediate score vector:

s³(2)=(s³(1)+s¹(1)+s⁴(1))÷3; and

4. RN⁴ receives s²(1) and s³(1) and generates a second intermediate score vector:

s⁴(2)=(s⁴(1)+s²(1)+s³(1))÷3.

The process is repeated in subsequent iterations until each of s¹, s², s³, and s⁴ converge to the approximate average of s¹(0), s²(0), s³(0), and s⁴(0).

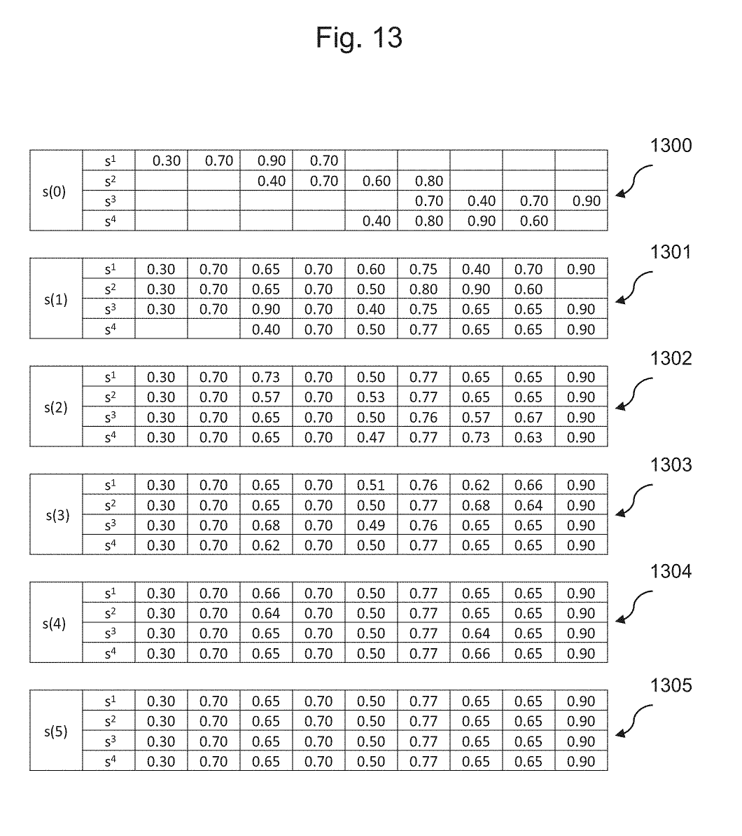

FIG. 13 illustrates, by way of non-limiting example, the actual score vectors of each of s¹, s², s³ and s⁴ initially (1300), after a first averaging iteration (1301), after a second averaging iteration (1302), after a third averaging iteration (1303), after a fourth averaging iteration (1304), and after a fifth averaging iteration (1305). As shown, after five iterations each of s¹, s², s³ and s⁴ have converged to at least a good approximation of the actual average (s¹+s²+s³+s⁴)/4.

As detailed above, in some cases it may be advantageous for each RN to share, for the purpose of averaging, only its top n similarity scores initially and after each averaging iteration, rather than all of its similarity scores (e.g. to save bandwidth by limiting the amount of data transferred).

The initial score vectors generated by each RN may also be fused using other suitable methods known to those skilled in the art. See, e.g, V. Blondel, J. M. Hendrickx, A. Olshevsky and J. N. Tsitsiklis, “Convergence in multi-agent coordination, consensus, and flocking”, Proc. 44th IEEE Conf. Decision and Control, 2005 and 2005 Eur. Control Conf. (CDC-ECC \'05), pp.2996-3000, 2005.

Returning now to FIG. 10, upon at least one RN having generated a compatible final score vector, the at least one RN can take a decision as to the identity of the subject by associating (1013) the face image with the subject having the highest averaged score. In certain embodiments, any one or more RNs can perform the associating (1013) thereby taking a recognition decision. In certain embodiments, the associating (1013) is made only if the highest score is higher than a predefined threshold. If not, no enrolled subjects are associated with the face image. In certain embodiments, as detailed above with reference to FIGS. 4 and 11B, two or more vector elements can be associated with the same subject, for at least some of the subjects. In such cases, instead of selecting the subject corresponding to the highest score, an arbitrary classification procedure such as K-nearest neighbour selection can be used (e.g. using a predetermined value for K). Other classification methods known to persons skilled in the art can also be used.

It is noted that the teachings of the presently disclosed subject matter are not bound by the flow charts illustrated in FIGS. 4 and 10; the illustrated operations can occur out of the illustrated order. It is also noted that whilst the flow chart is described with reference to elements of system (10), this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A method of operating a plurality of operatively interconnected processing nodes to associate a face image with a subject out of a plurality of subjects, comprising:
by each node out of the plurality of processing nodes:
obtaining, at least part of the face image;
extracting features of the obtained at least part of the face image thereby generating a feature template comprising the extracted features, the features extracted by any given node being different than the features extracted by at least one other node;
comparing the feature template generated by the node with each subject template out of a plurality of subject templates stored in the node, each stored subject template comprising features of a corresponding at least part of a face image of a different subject out of the plurality of subjects, and calculating an initial similarity score in respect of each comparison, thereby generating an initial score vector informative of a plurality of initial similarity scores associated with a respective plurality of subjects;
averaging the initial similarity score vectors generated by the node and by at least two predefined nodes out of the plurality of processing nodes, thereby giving rise to an intermediate similarity score vector;
repeatedly averaging the intermediate similarity score vectors generated by the node and by the at least two predefined nodes until a convergence condition is met, thereby generating a final score vector compatible for all nodes out of the plurality of processing nodes and informative of one or more average similarity scores, each associated with a respective subject out of the plurality of subjects;
associating, by at least one node out of the plurality of processing nodes, the face image with the subject that corresponds to the highest score in the node's final score vector.

2. The method of claim 1 wherein obtaining at least part of the face image comprises obtaining one or more face module images extracted from the face image, each face module image associated with a respective face module.

3. The method of claim 2 wherein the one or more face module images obtained by any given node are different than the one or more face module images obtained by at least one other node.

4. The method of claim 3 wherein each node is associated with a given one or more face modules, and each node obtains the one or more face module images associated with the node's associated one or more face modules.

5. The method of claim 4 wherein at least two nodes are associated with the same one or more face modules, and each of the at least two nodes extracts features of the obtained one or more face module images using a plurality of feature extractors stored in the node, wherein the plurality of feature extractors stored in a first one of the at least two nodes is different than the plurality of feature extractors stored in a second one of the at least two nodes.

6. The method of claim 5 wherein the first one of the at least two nodes has stored therein a first plurality of subject templates and the second one of the at least two nodes has stored therein a second plurality of subject templates different from said first plurality of subject templates.

7. The method of claim 1 wherein averaging the intermediate similarity vectors is performed in each iteration out of a plurality of iterations, and wherein the convergence condition is met upon the number of iterations reaching a predetermined threshold.

8. The method of claim 1 wherein averaging the intermediate similarity vectors is performed in each iteration out of a plurality of iterations, and wherein the convergence condition is met upon a difference between an intermediate score vector generated in the n^{th} iteration and the intermediate score vector generated in the (n-1)^{th} iteration being less than a predetermined threshold.

9. The method of claim 1 wherein the face image is associated with the subject corresponding to the highest score when the highest score is above a predetermined threshold.

10. The method of claim 1 wherein averaging the initial similarity score vectors generated by a given node and at least two predefined nodes comprises selecting the top n scores from each of the node and the at least two predefined nodes and averaging the selected scores.

11. A face recognition system for associating a face image with a subject out of a plurality of subjects, comprising:
a plurality of operatively interconnected processing nodes, each node comprising a processor operatively coupled to a memory and configured to:
obtain, from the memory, at least part of the face image;
extract features of the obtained at least part of the face image thereby generating a feature template comprising the extracted features, the features extracted by any given node being different than the features extracted by at least one other node;
compare the feature template generated by the node with each subject template out of a plurality of subject templates stored in the node, each stored subject template comprising features of a corresponding at least part of a face image of a different subject out of the plurality of subjects, and calculate an initial similarity score in respect of each comparison, thereby generating an initial score vector informative of a plurality of initial similarity scores associated with a respective plurality of subjects;
average the initial similarity score vectors generated by the node and by at least two predefined nodes out of the plurality of processing nodes, thereby giving rise to an intermediate similarity score vector;
repeatedly average the intermediate similarity score vectors generated by the node and by the at least two predefined nodes until a convergence condition is met, thereby generating a final score vector compatible for all nodes out of the plurality of processing nodes and informative of one or more average similarity scores, each associated with a respective subject out of the plurality of subjects;
wherein at least one node out of the plurality of processing nodes associates the face image with the subject that corresponds to the highest score in the node's final score vector.

12. The system of claim 11 wherein obtaining at least part of the face image comprises obtaining one or more face module images extracted from the face image, each face module image associated with a respective face module, and wherein the one or more face module images obtained by any given node are different than the one or more face module images obtained by at least one other node.

13. The system of claim 12 wherein each node is associated with a given one or more face modules, and each node obtains the one or more face module images associated with the node's associated one or more face modules.

14. The system of claim 13 wherein in at least two nodes are associated with the same one or more face modules, and each of the at least two nodes extracts features of the obtained one or more face module images using a plurality of feature extractors stored in the node, wherein the plurality of feature extractors stored in a first one of the at least two nodes is different than the plurality of feature extractors stored in a second one of the at least two nodes.

15. The system of claim 14 wherein the first one of the at least two nodes has stored therein a first plurality of subject templates and the second one of the at least two nodes has stored therein a second plurality of subject templates different from said first plurality of subject templates.

16. The system of claim 11 wherein averaging the intermediate similarity vectors is performed in each iteration out of a plurality of iterations, and wherein the convergence condition is met upon at least one of: the number of iterations reaching a predetermined threshold, and the difference between an intermediate score vector generated in the n^{th} iteration and the intermediate score vector generated in the (n-1)^{th} iteration being less than a predetermined threshold.

17. The system of claim 11 wherein the face image is associated with the subject corresponding to the highest score when the highest score is above a predetermined threshold.

18. The system of claim 11 wherein averaging the initial similarity score vectors generated by a given node and at least two predefined nodes comprises selecting the top n scores from each of the node and the at least two predefined nodes and averaging the selected scores.

19. A non-transitory storage medium comprising instructions embodied therein, that when executed by a processor comprised in a processing node operatively interconnected to a plurality of processing nodes, cause the processor to perform a method of associating a face image with a subject out of a plurality of subjects, the method comprising:
obtaining, at least part of the face image;
extracting features of the obtained at least part of the face image thereby generating a feature template comprising the extracted features, the features extracted by the node being different than the features extracted by at least one other node in the plurality of nodes;
comparing the feature template generated by the node with each subject template out of a plurality of subject templates stored in the node, each stored subject template comprising features of a corresponding at least part of a face image of a different subject out of the plurality of subjects, and calculating an initial similarity score in respect of each comparison, thereby generating an initial score vector informative of a plurality of initial similarity scores associated with a respective plurality of subjects;
averaging the initial similarity score vectors generated by the node and by at least two predefined nodes out of the plurality of processing nodes, thereby giving rise to an intermediate similarity score vector;
repeatedly averaging the intermediate similarity score vectors generated by the node and by the at least two predefined nodes until a convergence condition is met, thereby generating a final score vector compatible for all nodes out of the plurality of processing nodes and informative of one or more average similarity scores, each associated with a respective subject out of the plurality of subjects; and
associating the face image with the subject that corresponds to the highest score in the node's final score vector.

20. A method of recognizing a subject out of a plurality of subjects as corresponding to a captured face image, the recognizing provided using at least one source node (SN) and a plurality of recognizer nodes (RN) operatively coupled to the SN, each RN associated with at least one face module (FM) of a plurality of FMs, the method comprising:
extracting, by the SN, from the captured face image a plurality of FM images corresponding to the plurality of FMs, and transferring the extracted FM images to the plurality of RNs, wherein a given FM image is transferred to at least one RN associated with the FM corresponding to the given FM image, and wherein each RN receives at least one FM image;
for each given FM image, at one or more RNs:
extracting at least a subset of FM features from the received FM image, thereby generating a FM template comprising features of the FM image;
comparing the generated FM template to a plurality of templates stored at the RN, each stored template associated with the corresponding FM of a respective subject out of the plurality of subjects;
generating a similarity score in respect of one or more subjects out of the plurality of subjects, the similarity score generated in respect of a given subject being indicative of a similarity measure between the FM template and a stored template associated with the given subject;
for at least part of the plurality of subjects, averaging, by the plurality of RNs, similarity scores generated by different RNs in respect of the same subject, thereby giving rise to a plurality of average similarity scores each associated with a respective subject of the at least part of the plurality of subjects;
determining, by at least one RN, the subject corresponding to the captured face image as the subject having the highest averaged score out of the plurality of average similarity scores.
